(19) United States
(12) Patent Application Publication
(10) Pub. No.: US 2005/0006527 A1
(43) Pub. Date: Jan. 13, 2005

(54) Background radiation masking system

(76) Inventor: Joseph Gerard Conley, Baltimore, MD (US)

Correspondence Address: Joseph Gerard Conley, 3201 Rosekemp Avenue, Baltimore, MD, 21214, US

(21) Appl. No.: 10/614,567

(22) Filed: Jul. 7, 2003

(51) Int. Cl. B64C 1/10

(52) U.S. Cl. 244/121

(57) ABSTRACT

This method of detecting aircraft is by the missing cosmic background radiation that they block out. This raditation is normaly spread across the entire sky; except when something blocks it out such as a aircraft flying in front of it. It works like a radar but it does not send out a signal.

### CROSS REFERENCE TO RELATED APPLICATION

None found.

### STATEMENT REGARDING FED SPONSORED R&D

Not applicatable.

### BACKGROUND OF INVENTION

Stealth and other aircraft block out cosmic background radiation as they move through the sky. This can be detected and tracked.

### BRIEF SUMMARY OF THE INVENTION

These aircraft must duplicate the radiation that they have blocked out, and this when radiated, will make them almost impossible to detect by its loss of presence.

### DRAWINGS

None.

### DETAILED DESCRIPTION OF THE INVENTION

Aircraft would be fitted with antennae to receive the cosmic radiation and then it would be electronically reproduced by the aircraft's avionics to replace the blocked natural radiation.

1. I claim that this will make it virtuly invisible to the method of detecting and tracking the aircraft by the missing natural background radiation.
